(19) United States
(12) Patent Application Publication
(10) Pub. No.: US 2005/0168978 A1
(43) Pub. Date: Aug. 4, 2005

(54) Focusing flashlight

(76) Inventor: Manho Yang, Guangdong Province (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/510,176

(22) PCT Filed: Apr. 3, 2003
(86) PCT No.: PCT/CN02/00585

(30) Foreign Application Priority Data
Apr. 3, 2002 (CN) 02226592.9

(51) Int. Cl. F21L 4/04

(52) U.S. Cl. 362/202

(57) ABSTRACT

The invention involves a focusing flashlight, the flashlight includes the tail cover, housing body, and a reflector and a bulb holder installed in the housing body. Therein, the reflector and the bulb holder are connected to each other by the threads in order to adjust the position of the bulb. Between the reflector and the bulb holder, there is installed a lock device to fix the relative position of the reflector and the bulb holder. The focusing flashlight has a lot of advantages, for example, the focusing performance being reliable, the focusing performance after focusing being unaffected by the rotation of the front cover and the housing head, the structure being simple, and, convenient.

### TECHNICAL FIELD

The present invention relates to a focusing flashlight.

### BACKGROUD OF THE INVENTION

The common flashlights can be classified into focusing flashlights and unfocusing flashlights deponding on whether the flashlights can focus or not. The focusing flashlights generally perform the focusing by rotating the housing head or the front cover to allow the luminous point of the bulb and the focus of the parabolic reflector coinciding. But this kind of focusing flashlight has a disadvantage that when the user rotates the housing head or the front cover unconsciously and the focus of the reflector mismatches with the lighting point of the bulb, the lights will scatter, and a readjustment of focusing is needed. Unfocusing flashlights fix the relative positions of the reflector and the bulb. The bulbs of some unfocusing flashlights can not be replaced in the case of something wrong with them, whereas some others can be replaced. Even if the bulb can be replaced, the flashlight with the replaced bulb is not focused because the actual height of filament in each bulb is variable somewhat.

### SUMMARY OF THE INVENTION

The present invention is directed to overcome the above-mentioned disadvantages of the prior flashlights and provide a focusing flashlight which enables the relative position of the luminous point of the bulb to the parabolic focus the reflector to be adjusted, and after the assembly is fulfilled, the position of the bulb and the reflector is relatively fixed. Thus the focusing performance of the light is not affected by the rotation of the front cover or the housing head.

In order to realize the above objects, the present invention provides a focusing flashlight, the flashlight includes the tail cover, housing body, and a reflector and a bulb holder installed on the housing body. Wherein, the reflector and the bulb holder are connected with each other by the screw threads to adjust the position of bulb. And between the reflector and the bulb holder, there is installed a lock device to fix the relative position of the reflector and the bulb holder.

The focusing flashlight according to the invention has a lot of advantages compared with the prior art, for example, the focusing performance being reliable and being not affected by the rotation of the front cover and the housing head after focusing, the structure being simple, operation being convenience, and so on.

### BRIEF DESCRIPTION OF THE DRAWINGS

FIG. 1 is the three-dimensional exploded view of the focusing flashlight according to the first embodiment of the present invention, wherein only the reflector, the lock device and the bulb holder are showed.

FIG. 2 shows schematically the assembly of the reflector, the lock device and bulb holder in FIG. 1.

FIG. 3 is a sectional view taken along the line A-A in FIG. 2.

FIG. 4 shows schematically the reflector, the lock device and the bulb holder mounted on the housing body of the flashlight.

FIG. 5 is the three-dimensional exploded view of the focusing flashlight according to the second embodiment of the present invention, wherein only the reflector, the lock device and the bulb holder are showed.

FIG. 6 is the three-dimensional exploded view of the focusing flashlight according to the third embodiment of the present invention, wherein only the reflector, the lock device and the bulb holder are showed.

FIG. 7 shows schematically the assembly of the reflector, the lock device and bulb holder in FIG. 6.

FIG. 8 is the three-dimensional exploded view of the focusing flashlight according to the fourth embodiment of the present invention, wherein only the reflector, the lock device and the bulb holder are showed.

### DESCRIPTION OF THE PREFERRED EMBODIMENT

The preferred embodiments of the present invention will now be discussed in detail with reference to the accompanying drawings.

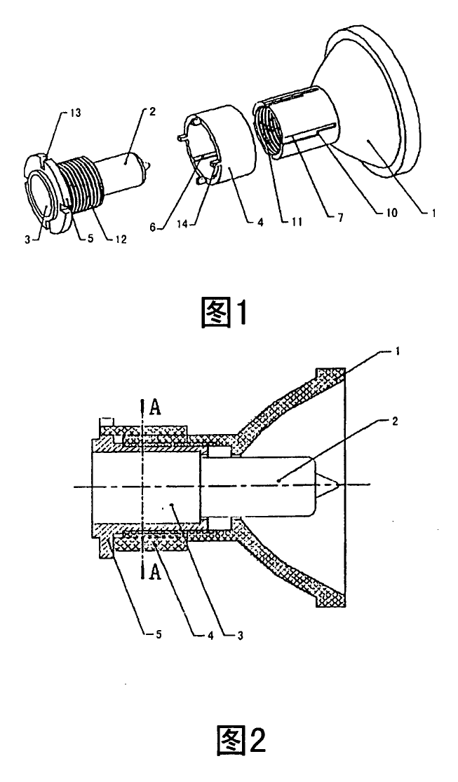

According to the present invention, the flashlight comprises a tail cover, a housing body, batteries in the housing body, and a reflector, a lock device and a bulb holder which are assembled together and then mounted on the housing body. FIG. 1 is the three-dimensional exploded view of the focusing flashlight according to the first embodiment of the present invention, wherein only the reflector 1, the lock device 4 and the bulb holder are showed. As shown in FIG. 1, the reflector 1 comprises a parabolic lampshade and a barrel portion 10 integrally attached to the top end of the lampshade. The inner screw threads 11 are formed on the inner wall of the barrel portion 10 of the reflector 1 and the grooves 7 elongated along the axial direction of the barrel portion 10 are formed on the outer wall at equal intervals in the circumference direction. The grooves 7 do not penetrate the wall of the barrel portion 10 and the width of the grooves 7 is not uniform, with the portion of the grooves near the lampshade being relatively smaller and that near the free end growing larger. The portion with larger width can extend in the circumference direction to either one of or both sides relative to the narrower portion.

The lock device 4 is a cylindrical part with an inside diameter approximately equivalent to the outside diameter of the barrel portion 10 of the reflector 1. The protruding ribs 6 are formed in the axial direction on the inner wall of the lock device 4 at equal intervals to be engaged with the grooves7 of the barrel portion 10 of the reflector 1, and the height of the protruding ribs is approximately equal to the depth of the grooves 7. The projections 14 project in the axial direction from the end of the lock device 4 away from the reflector 1 at equal intervals. The number of the grooves 7 formed on the reflector 1 is the same as or an integral multiple of the number of the protruding ribs 6 formed on the lock device 4.

The bulb holder comprises a bulb-holding base 5 and a bulb-inserting base 3. The bulb-holding base 5 is formed in the shape of a hollow cylinder and has a flange on one of its ends. The bulb-inserting base 3 with bulb 2 installed therein is inserted into the hollow portion of the bulb-holding base 5. The outer screw threads 12 are formed on the outer wall of the cylindrical portion of the bulb-holding base 5 to be engaged with the inner screw threads 11 formed on the inner wall of the barrel portion 10 of the reflector 1, and a plurality of recesses 13 corresponding to the projections 14 of the lock device 4 are formed on the flange of the bulb-holding base 5 at equal intervals in the circumference direction. The number of the recesses 13 formed on the flange of the bulb-holding base 5 is the same as or an integral multiple of the number of the projections 14 formed on the lock device 4.

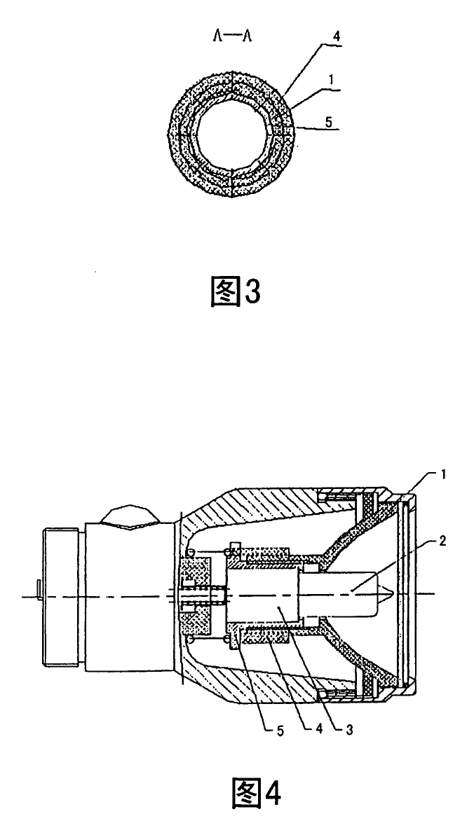

FIG. 2 shows schematically the assembly of the reflector, the lock device and the bulb holder in FIG. 1; FIG. 3 is a sectional view taken along the line A-A in FIG. 2. In assembling, the protruding ribs 6 are inserted into the grooves 7 of the barrel portion 10 of the reflector 1 so that the lock device 4 is set around the exterior of the barrel portion 10 of the reflector 1. And then, the bulb holder is mounted on the reflector 1 by screwing the outer screw threads 12 of the bulb-holding base 5 on the inner screw threads 11 of the reflector 1. FIG. 4 shows schematically the reflector, the lock device and the bulb holder which are mounted on the housing body of the flashlight. After the reflector, the lock device and the bulb holder are assembled, they can be installed integrally on the housing body of the flashlight to form a integrated flashlight.

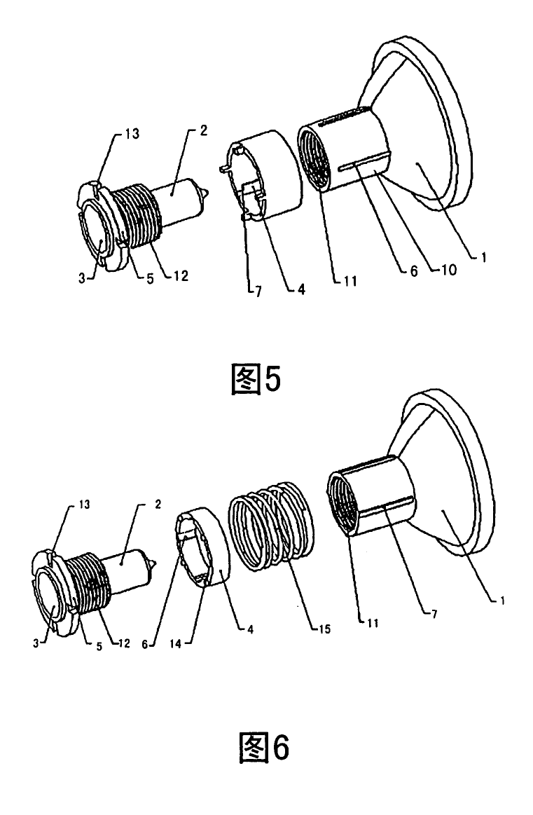

FIG. 5 is the three-dimensional exploded view of the focusing flashlight according to the second embodiment of the present invention, wherein only the reflector, the lock device and the bulb holder are showed. The second embodiment is almost the same as the first embodiment, except that the positions of the protruding ribs 6 and the grooves 7 are varied. In the second embodiment, the protruding ribs 6 are formed in the axial direction on the outer wall of the barrel portion 10 of the reflector 1 at equal intervals, and the grooves 7 to be engaged with the protruding ribs 6 are formed on the inner wall of the lock device 4 at equal intervals in the circumference direction. The width of the grooves 7 is not uniform, with the end near the bulb holder being narrower and the end near the reflector 1 growing wider.

During the focusing after the bulb 2 is installed, the lock device 4 coupled with the barrel portion 10 of the reflector 1 is firstly slid toward the lampshade of the reflector 1 so that the projections 14 of the lock device 4 are disengaged from the recesses 13 on the flange of the bulb-holding base 5, and thus allow the bulb-holding base 5 to rotate. As the bulb-holding base 5 is rotated, the bulb 2 moves backwards and forwards with the bulb-holding base 5 under the guiding of the outer screw threads 12 of the bulb holder, so that the luminous point of the bulb 2 is coincided with the focus of the parabolic lampshade to gain the optimal focusing effects. Subsequently, the lock device 4 coupled with the barrel portion 10 of the reflector 1 is slid toward the flange of the bulb-holding base 5 and the projections 14 of the lock device 4 are inserted into the recesses 13 on the flange of the bulb-holding base 5. And then, the lock device 4 is slightly rotated to move the protruding ribs 6 away from the position aligning with the narrow portion of the grooves 7. Thus, the lock device 4 can not move to and fro on the reflector 1 and the positions of the bulb 2 and the reflector 1 can remain relatively fixed.

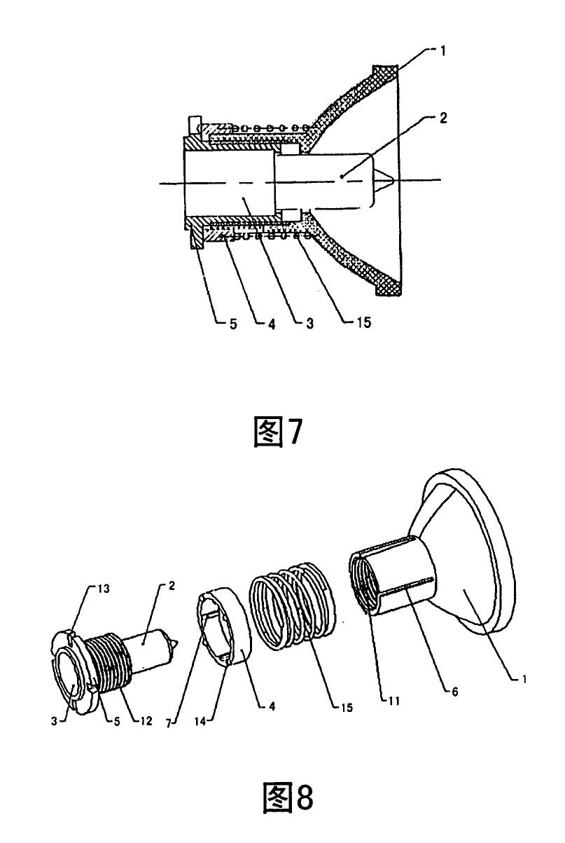

FIG. 6 is the three-dimensional exploded view of the focusing flashlight according to the third embodiment of the present invention, wherein only the reflector, the lock device and the bulb holder are showed. In the third embodiment, the shape of the grooves 7 formed on the reflector 1 is different from that in the first embodiment, and the grooves 7 are straight grooves with a uniform width. In addition, a spring 15 around the barrel portion 10 of the reflector 1 is set between the lock device 4 and the reflector 1. The other structures of this embodiment are the same as the first embodiment. FIG. 7 shows schematically the assembly of the reflector, the lock device and the bulb holder in FIG. 6. As shown in FIG. 7, the projections 14 of the lock device 4 are kept in the recesses 13 on the flange of the bulb-holding base 5 under the action of the spring 15.

FIG. 8 is the three-dimensional exploded view of the focusing flashlight according to the fourth embodiment of the present invention, wherein only the reflector, the lock device and the bulb holder are showed. The fourth embodiment is almost the same as the third embodiment except that the positions of the protruding ribs 6 and the grooves 7 are different. In the fourth embodiment, the protruding ribs 6 are formed in the axial direction on the outer wall of the barrel portion 10 of the reflector 1 at equal intervals, and the grooves 7 to be engaged with the protruding ribs 6 are formed on the inner wall of the lock device 4 at equal intervals in the circumference direction. The grooves 7 are also the straight grooves with a uniform width.

For the flashlights according to the third and the fourth embodiments of the present invention, in focusing after the bulb 2 is installed, the lock device 4 coupled with the barrel portion 10 of the reflector 1 is firstly moved toward the lampshade of the reflector 1 with overcoming the elasticity of the spring 15, so that the projections 14 of the lock device 4 are disengaged from the recesses 13 on the flange of the bulb-holding base 5, and thus enable the bulb-holding base 5 to rotate. As the bulb-holding base 5 is rotated, the bulb 2 will move forwards and backwards with the bulb-holding base 5 under the guiding of the outer screw threads 12 of the bulb holder, thereby the luminous point of the bulb 2 is coincided with the focus of the parabolic lampshade to gain the optimal focusing effects. Then, the external force applied on the lock device 4 is released, and the lock device 4 moves toward the bulb-holding base 5 under the action of the elasticity of the spring 15, the projections 14 of the lock device 4 is remained in the recesses 13 on the flange of the bulb-holding base 5. And thus, the lock device 4 cannot move to and fro on the reflector 1 and the positions of the bulb 2 and the reflector 1 can remain relatively fixed.

The present invention is not restricted by the above description. For instance, the said projections can be formed on the side of the flange of the bulb holder facing the lock device, while the said recesses can be formed on the said lock device. Those skilled in the art can make a lot of variations in the present invention without departing from the scope of the claims of the invention.

1. A focusing flashlight, comprising:
a tail cover,
a reflector and a bulb holder installed on a housing body, wherein the reflector and the bulb holder are connected by a plurality of screw threads to adjust the position of a bulb; and
a lock device between the reflector and the bulb holder to fix the relative position of the reflector and the bulb holder.

2. The focusing flashlight according to claim 1, further comprising
a plurality of grooves elongated in an axial direction are formed on an outer wall of a barrel portion of the reflector at equal intervals; the lock device is a cylindrical part with protruding ribs formed on an inner wall at equal intervals to be engaged with the grooves and with projections formed on an end facing the bulb holder at equal intervals; and the bulb holder is provided with a flange on an end contacting the housing body and a plurality of recesses for receiving the projections are formed on the said flange at equal intervals.

3. The focusing flashlight according to claim 1, further comprising the plurality of grooves elongated in the axial direction are formed on the outer wall of the barrel portion of the reflector at equal intervals; the lock device is a cylindrical part with protruding ribs formed on the inner wall at equal intervals to be engaged with the grooves and with the recesses formed on the end facing the bulb holder at equal intervals; and the bulb holder is provided with a flange on the end contacting the housing body and the flange is provided with a plurality of projections on the side facing the lock device at equal interval to be engaged with the recesses.

4. The focusing flashlight according to claim 2, further comprising an inside diameter of the lock device is approximately equal to an outside diameter of the barrel portion of the reflector; the grooves not penetrating the wall of the barrel portion of the reflector; and the depth of the grooves is approximately equal to the height of the protruding ribs.

5. The focusing flashlight according to claim 2, further comprising the width of the grooves formed on the outer wall of the barrel portion of the reflector is not uniform, with the portion of the grooves near a lampshade portion of the reflector being relatively narrower and the portion of the grooves near the bulb holder growing larger.

6. The focusing flashlight according to claim 2, further comprising the width of the grooves on the outer wall of the barrel portion of the reflector is uniform, and a spring around the barrel portion of the reflector is provided between the lock device and the reflector.

7. The focusing flashlight according to claim 1, further comprising the plurality of protruding ribs elongated in the axial direction are formed on the outer wall of the barrel portion of the reflector at equal intervals, the lock device is a cylindrical part with grooves formed on the inner wall at equal intervals to be engaged with the protruding ribs and with projections formed on the end facing the bulb holder at equal intervals; and the bulb holder is provided with a flange on the end contacting the housing body and the plurality of recesses for receiving the projections are formed on the flange at equal intervals.

8. The focusing flashlight according to claim 1, further comprising the plurality of protruding ribs elongated in the axial direction are formed on the outer wall of the barrel portion of the reflector at equal intervals; the lock device is a cylindrical part with grooves formed on the inner wall at equal intervals to be engaged with the protruding ribs and with the recesses formed on the end facing the bulb holder at equal intervals; and the bulb holder is provided with a flange on the end contacting the housing body and the flange is provided with a plurality of projections on the facing the lock device a equal intervals to be engaged with the recesses.

9. The focusing flashlight according to claim 7, further comprising the inside diameter of the lock device is approximately equal to the outside diameter of the barrel portion of the reflector; the grooves not penetrating the wall of the lock device; and the depth of the grooves is approximately equal to the height of the protruding ribs.

10. The focusing flashlight according to claim 7, further comprising the width of the grooves formed on the inner wall of the lock device is not uniform, with the portion of the grooves near the lampshade of the reflector being larger and the portion of the grooves near the bulb holder becoming smaller.

11. The focusing flashlight according to claim 7, further comprising the width of the grooves formed on the inner wall of the lock device is uniform, and a spring around the barrel portion of the reflector is provided between the lock device and the reflector.

12. The focusing flashlight according to claim 2, the number of the grooves is the same as or an integral multiple of the number of the said protruding ribs.

13. The focusing flashlight according to claim 2, the number of the recesses is the same as or an integral multiple of the number of the said projections.

14. The focusing flashlight according to claim 1, further comprising the screw threads include the inner screw threads formed on the inner wall of the barrel portion of the said reflector and the outer screw threads formed on the outer wall of the bulb holder and to be engaged with the inner screw threads.

15. The focusing flashlight according to claim 3, further comprising an inside diameter of the lock device is approximately equal to an outside diameter of the barrel portion of the reflector; the grooves not penetrating the wall of the barrel portion of the reflector; and the depth of the grooves is approximately equal to the height of the protruding ribs.

16. The focusing flashlight according to claim 3, further comprising the width of the grooves formed on the outer wall of the barrel portion of the reflector is not uniform, with the portion of the grooves near a lampshade portion of the reflector being relatively narrower and the portion of the grooves near the bulb holder growing larger.

17. The focusing flashlight according to claim 3, further comprising the width of the grooves on the outer wall of the barrel portion of the reflector is uniform, and a spring around the barrel portion of the reflector is provided between the lock device and the reflector.

18. The focusing flashlight according to claim 8, further comprising the inside diameter of the lock device is approximately equal to the outside diameter of the barrel portion of the reflector; the grooves not penetrating the wall of the lock device; and the depth of the said grooves is approximately equal to the height of the protruding ribs.

19. The focusing flashlight according to claim 8, further comprising the width of the grooves formed on the inner wall of the lock device is not uniform, with the portion of the grooves near the lampshade of the reflector being larger and the portion of the grooves near the bulb holder becoming smaller.

20. The focusing flashlight according to claim 8, further comprising the width of the grooves formed on the inner wall of the lock device is uniform, and a spring around the barrel portion of the reflector is provided between the lock device and the reflector.

21. The focusing flashlight according to claim 3, further comprising the number of the grooves is the same as or an integral multiple of the number of the said protruding ribs.

22. The focusing flashlight according to claim 7, further comprising the number of the grooves is the same as or an integral multiple of the number of the said protruding ribs.

23. The focusing flashlight according to claim 8, further comprising the number of the grooves is the same as or an integral multiple of the number of the said protruding ribs.

24. The focusing flashlight according to claim 3, further comprising the number of the recesses is the same as or an integral multiple of the number of the projections.

25. The focusing flashlight according to claim 7, further comprising the number of the recesses is the same as or an integral multiple of the number of the projections.

26. The focusing flashlight according to claim 8, further comprising the number of the recesses is the same as or an integral multiple of the number of the projections.
